(19) United States
(12) Patent Application Publication
(10) Pub. No.: US 2005/0256846 A1
(43) Pub. Date: Nov. 17, 2005

(54) Interactive client-server data search

(75) Inventors: Daniel J. Zigmond, Menlo Park, CA (US); Samuel Thomas Scott III, Los Gatos, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/844,091

(22) Filed: May 12, 2004

(51) Int. Cl. G06F 7/00

(52) U.S. Cl. 707/3

(57) ABSTRACT

An interactive client-server data search involves accepting search-related inputs from a user at a client and having the search performed on a data collection at a server. To reduce transmission latencies, the client prefetches search results prior to input from the user. When a user indicates that a search is to be requested, the client prefetches a sparse subset of data of a size that is sufficient to fill a search results display area of the client regardless of a first input character. In other words, a number of possible results for each character that might be first input is prefetched from the server. This number of possible results per character is set responsive to a number of displayable entries at the client. When a user actually inputs a character, the possible results for the input character is retrieved from the sparse subset of data and presented to the user.

### TECHNICAL FIELD

This disclosure relates in general to an interactive data search between a client and a server and in particular, by way of example but not limitation, to presenting search results from interactive data searches between a client and a server using sparse subsets of the searched data.

### BACKGROUND

Many modern television systems offer hundreds of channels. While customers enjoy having this many viewing options, trying to find a desirable program can be a daunting and time-consuming task. For example, the sheer number of channel options makes scrolling through every channel impractical. One feature used by such modern television systems to combat the overwhelming number of viewing options is the search feature. A user of a television device can activate a search feature and then enter letters until a looked-for title entry is provided on a display screen of the television device.

Some television systems today offer a search-as-you-type feature in which a list of title-matching programs that is provided on the display screen is automatically updated as a user enters additional letters. For example, when the user types “F,” the programs having titles starting with ‘F” are displayed. If the user next types “R,” then the list is narrowed to only those programs having titles starting with “FR.” This continues until the user either sees the program title he or she is looking for or decides to scroll manually through the resulting, narrowed list.

This program-title-searching feature may be offered to users by storing a complete list of all program titles on each user's client television device and by performing the program title search locally. Unfortunately, this requires that a large amount of program title data be stored on the client television device, which mandates a large memory storage capability. Furthermore, this local storage requires that the program title data be kept up-to-date, which can introduce significant overhead bandwidth traffic into a television-based network. This bandwidth traffic overhead can be especially severe when the list of available programs changes frequently and therefore causes the client television device to risk becoming out-of-date absent frequent updates of the locally-stored program title data.

Accordingly, there is a need for schemes and/or techniques that can provide a program-searching feature to users of client television devices in an up-to-date and/or efficient manner.

### SUMMARY

An interactive client-server data search involves accepting search-related inputs from a user at a client and having the search performed on an indexed data collection at a server. To reduce transmission latencies, the client prefetches search results prior to input from the user. When a user indicates that a search is to be requested, the client prefetches a sparse subset of data of a size that is sufficient to fill a search results display area of the client regardless of a first input character. In other words, a number of possible results for each character that might be input by the user is prefetched from the server. This number of possible results per character is set responsive to a number of displayable entries at the client. When a user actually inputs a character, the number of possible results for the input character is retrieved from the sparse subset of data and presented to the user.

The input character is also used to prefetch another sparse subset of data in which the input character is used as a one-character prefix for this other sparse subset of data. This other sparse subset of data now includes sufficient results for each possible second character to fill the search results display area of the client. Consequently, the visually-presented search results can be further narrowed responsive to the inputting of another character without waiting for another communication from the server. The procedure may continue until the user elects to manually scroll through the remaining, relatively narrow search results.

Other method, system, approach, apparatus, server, client, device, media, procedure, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram illustrating an example of a client providing a program search function via interaction with a server capable of performing a search of program data.

FIG. 2 illustrates an example of an index and a sparse subset with regard to a zero-character prefix for a program titles data structure.

FIG. 3 illustrates an example of an index and a sparse subset with regard to a one-character prefix for a program titles data structure.

FIG. 4 is a block diagram illustrating an example of an approach to a client-server interactive data search in which a search request having prefix information and search results having a sparse subset are exchanged between a client and a server.

FIG. 5 is a flow diagram that illustrates an example of a method for performing an interactive client-server data search responsive to user input along with a search results presentation.

### DETAILED DESCRIPTION

Introduction

Searches of program data are enabled using an interactive approach between a client device and a server. The client device is responsive to user input instructing the client device to effectuate a search of the program data. The program data is located at and the search is actually performed at the server. In this manner, effects from storage limitations at the client, as well as network traffic overhead from frequent programming data updates, are ameliorated.

When a user activates a search function, the client device prefetches from the server an initial sparse subset of all programming titles of the program data. A size of the sparse subset is established, at least in part, responsive to the number of display entries of a display screen associated with the client device. More specifically, the initial sparse subset may include a number of titles equal to the number of display entries times each character that may be in a programming title. For each given character of a total character set, the initial sparse subset includes a number of titles starting with the given character that equals the number of display entries.

When a user inputs an initial character, the portion of the initial sparse subset corresponding to the initial character is presented on the display screen by the client device, where the portion is of a size equal to the number of display entries. The client device also prefetches from the server a second sparse subset of programming titles of the program data that have the input initial character as their initial character. This second sparse subset also includes a number of titles equal to the number of display entries times each character that may be in a programming title, but the second sparse subset is selected from those titles that also start with the input initial character.

When a user inputs a second character, the portion of the second sparse subset, which portion is of a size equal to the number of display entries, corresponding to the second (and first) character is presented on the display screen by the client device. The client device also prefetches from the server a third sparse subset of programming titles of the program data that have the input initial character as their initial character and the input second character as the second character. This third sparse subset also includes a number of titles equal to the number of display entries times each character that may be in a programming title, but the third sparse subset is selected from those titles that also start with the input initial character and the input second character.

The accepting of additional user input and the prefetching of the next sparse subset may continue until the user attempts to scroll through a presented listing of a portion of a sparse subset. After scrolling is commenced, a dense listing that precedes or follows the currently-presented sparse subset may also be prefetched.

Example of Environment for Interactive Client-Server Data Searches

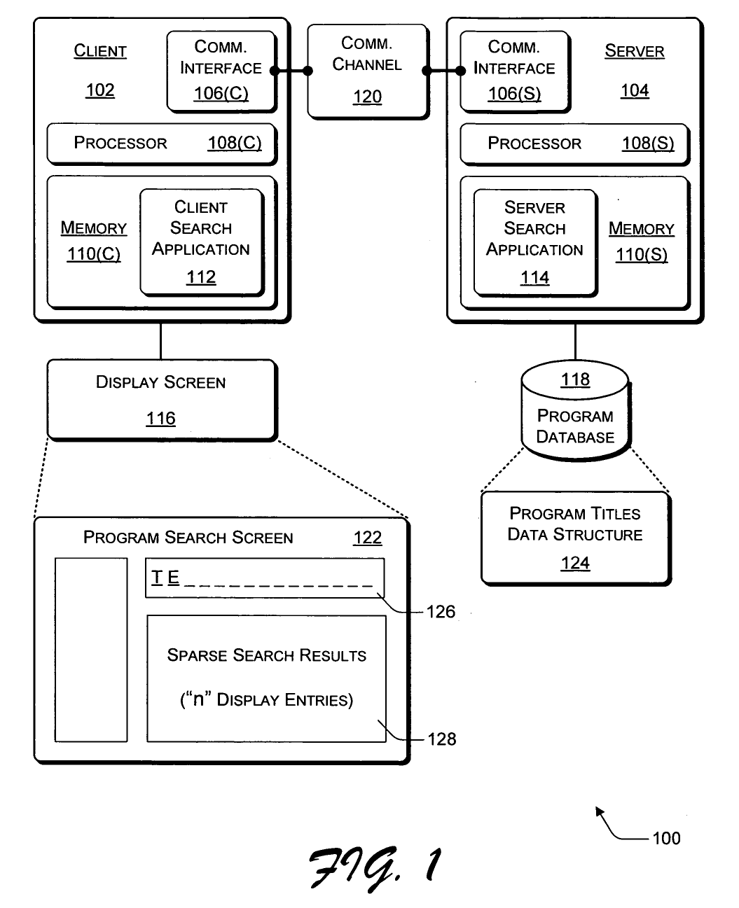

FIG. 1 is a block diagram 100 illustrating an example of a client 102 providing a program search function via interaction with a server 104 capable of performing a search of program data associated with program database 118. Client 102 is in communication with server 104 over a communication channel 120. In a described implementation, client 102 comprises a television-based device having an associated display screen 116, communication channel 120 comprises a television-based (e.g., cable, satellite, etc.) network or link(s) thereof, and server 104 comprises at least part of a headend or other node of a television-based network.

Client 102 receives television content, possibly from server 104, through communication channel 120. Such television content is displayed by client 102 on display screen 116. Display screen 116 may be integral with or merely connected (wirelessly or by wire) to client 102. Alternatively, client 102 may receive television content through a separate and different communication channel (not shown).

Client 102 includes one or more processors 108(C), at least one memory 110(C), and a communication interface 106(C) that is coupled to communication channel 120. Memory 110(C) includes processor-executable instructions that are executable by processor 108(C) to effectuate functions of client 102. Memory 110(C) may be realized as volatile and/or nonvolatile memory. More generally, client 102 may include and/or be coupled to media generally (e.g., electromagnetic or optical media) that may be volatile or non-volatile media, removable or non-removable media, storage or transmission media, some combination thereof, and so forth.

Memory 110(C) includes a client search application 112, which may comprise processor-executable instructions. More generally, client search application 112 may comprise hardware, software, firmware, or some combination thereof, and so forth. Although not explicitly shown, client 102 is capable of accepting user input (e.g., from a remote, a keypad, a touch pad/tablet, a keyboard, etc.). This user input may be provided to client search application 112.

In response to user input, client search application 112 enables a user to have a search performed on program data via interaction with server 104. Server 104 is described further herein below.

Specifically, client search application 112 is capable of presenting a program search screen 122 on display screen 116. Client search application 112 enables a user to input a search term at character input field 126. Two exemplary characters, “T” and “E”, are illustrated in character input field 126. The input search terms, using a search-as-the-user-types mechanism, are forwarded to server 104 as search requests (not shown in FIG. 1). Client search application 112 is also capable of presenting search results received from server 104 at search results field 128. Client 102 is adapted to display “n” entries in search results field 128, where “n” is set, at least partially, by a resolution capability of display screen 116.

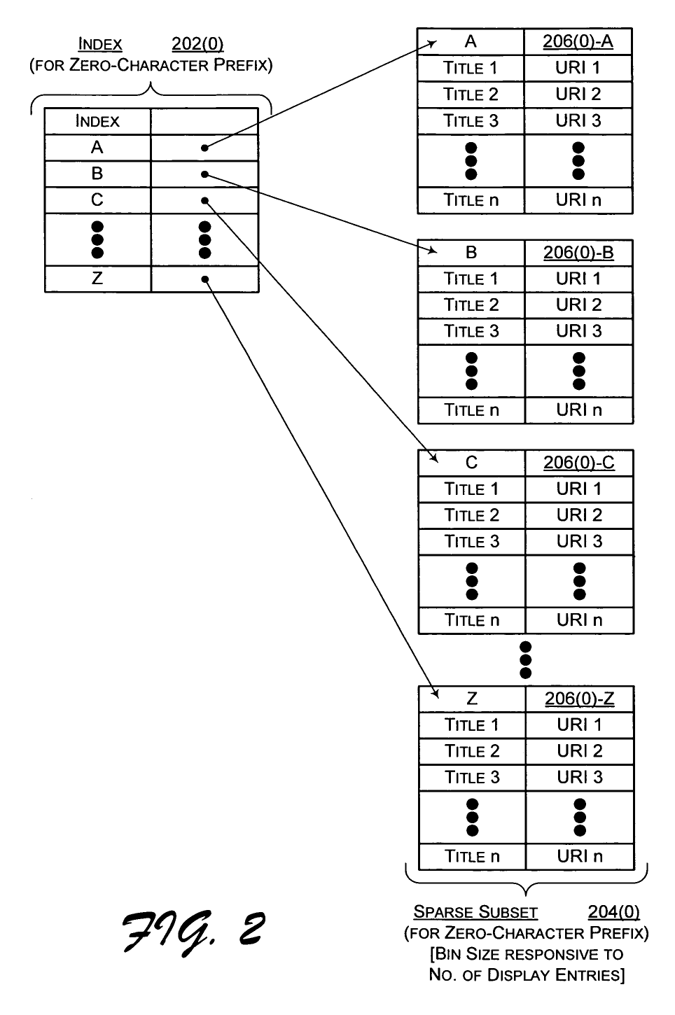

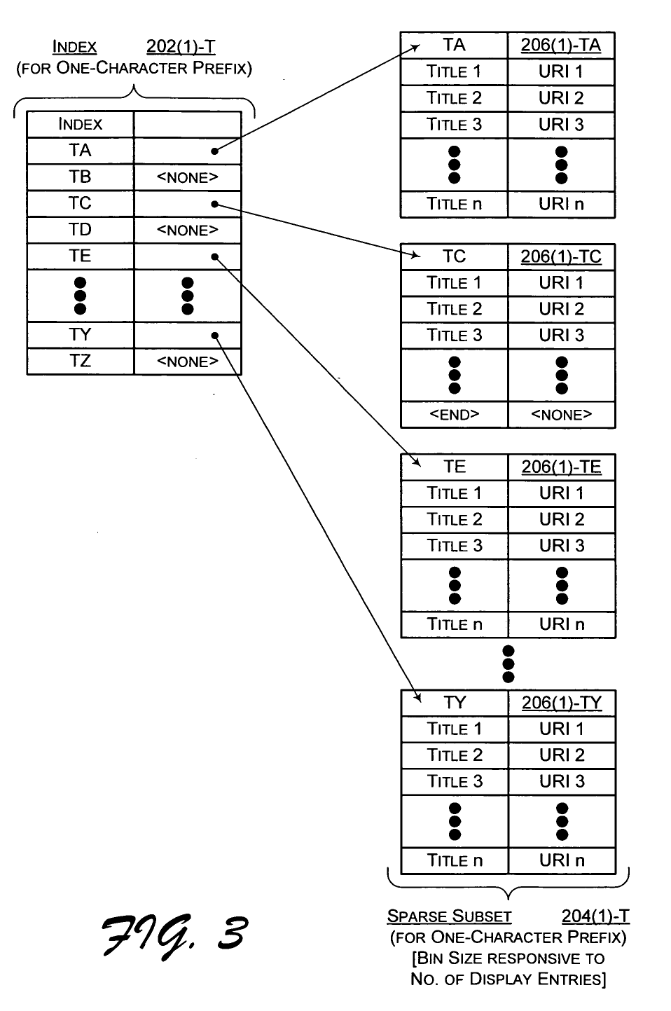

In order to present program search screen 122, client search application 112 may be part of, may include part of, and/or may work in conjunction with an electronic program guide (EPG) application (not shown). Such an EPG application and client search application 112 jointly present program search screen 122, including character input field 126 and search results field 128, on display screen 116. As is described further below with particular reference to FIGS. 2 and 3, sparse search results may be presented in search results field 128 by client search application 112.

Server 104 includes one or more processors 108(S), at least one memory 110(S), and a communication interface 106(S) that is coupled to communication channel 120. Memory 110(S) includes processor-executable instructions that are executable by processor 108(S) to effectuate functions of server 104. Memory 110(S) may be realized as volatile and/or nonvolatile memory. More generally, server 104 may include and/or be coupled to media generally (e.g., electromagnetic or optical media) that may be volatile or non-volatile media, removable or non-removable media, storage or transmission media, some combination thereof, and so forth.

Memory 110(S) includes a server search application 114, which may comprise processor-executable instructions. More generally, server search application 114 may comprise hardware, software, firmware, or some combination thereof, and so forth. Server search application 114 provides search-related access to program database 118. Program database 118 includes a program titles data structure 124. Program titles data structure 124 comprises program titles for those programs that are stored in program database 118. Program titles data structure 124 may be part of or separate from program database 118. As described further herein below, additional elements (e.g., informational aspects) of program database 118 (in addition to program titles) may also be searched by server search application 114. For example, program descriptions, actors, directors, producers, reviews, etc. may additionally be searched.

In response to search requests received from client 102, server search application 114 performs searches on program titles data structure 124 based on the search term characters that have thus far been input. The search produces a sparse subset of program titles that is based on the input characters of the search term. Server 104 then transmits these search results to client 102.

As noted above, local memory constraints as well as requisite data updating can render storing an entire program title database at client 102 costly and/or ineffective. The program-title-database-size problem is intensified with a digital video recording (DVR)-based system. In any given two-week period, there may be approximately 100,000 distinct programs being shown. It is relatively impractical to maintain a program title database containing 100,000 titles (much less 200,000 titles for a month) in local storage, especially when the program title listing is changing essentially constantly.

If the program title database is located and maintained at the server, then one approach is to do all client-initiated searches remotely at the server. However, this introduces a significant delay (e.g., approximately 500 milliseconds) into the search function of the user interface. In other words, each keystroke (including button presses) triggers a server query that can result in a half second delay for each letter before any search results are presented. In contradistinction to this approach, client search application 112 of client 102, in conjunction with server search application 114, prefetches sparse search results from server 104 prior to a relevant user input.

Client search application 112 recognizes that client 102 can display a predetermined (although possibly adjustable) number of program titles at any given time (e.g., 15 display entries in the following example). Consequently, for a 26-character character set, there are 390 (i.e., 15×26) possible program titles that may be relevant for a first keystroke. When a user initiates a search, client 102 requests an initial “sparse subset” of program titles (for zero-character prefixes) so that client search application 112 may respond immediately (e.g., without waiting for a communication from server 104) when the user types the first letter. A graphical depiction of a sparse subset is shown in FIG. 2 and in FIG. 3.

When the user begins inputting characters, client search application 112 performs two tasks. First, it searches through the prefetched initial sparse subset of program titles sent from server 104 to find the first 15 program titles starting with the input character, and it presents these 15 program titles on display screen 116. Second, client search application 112 sends a search request to server 104 for all of the program titles starting with that first input character (a one-character prefix). Once server 104 responds, client 102 can search locally through this new “dense subset” of program titles as the user presses additional keys.

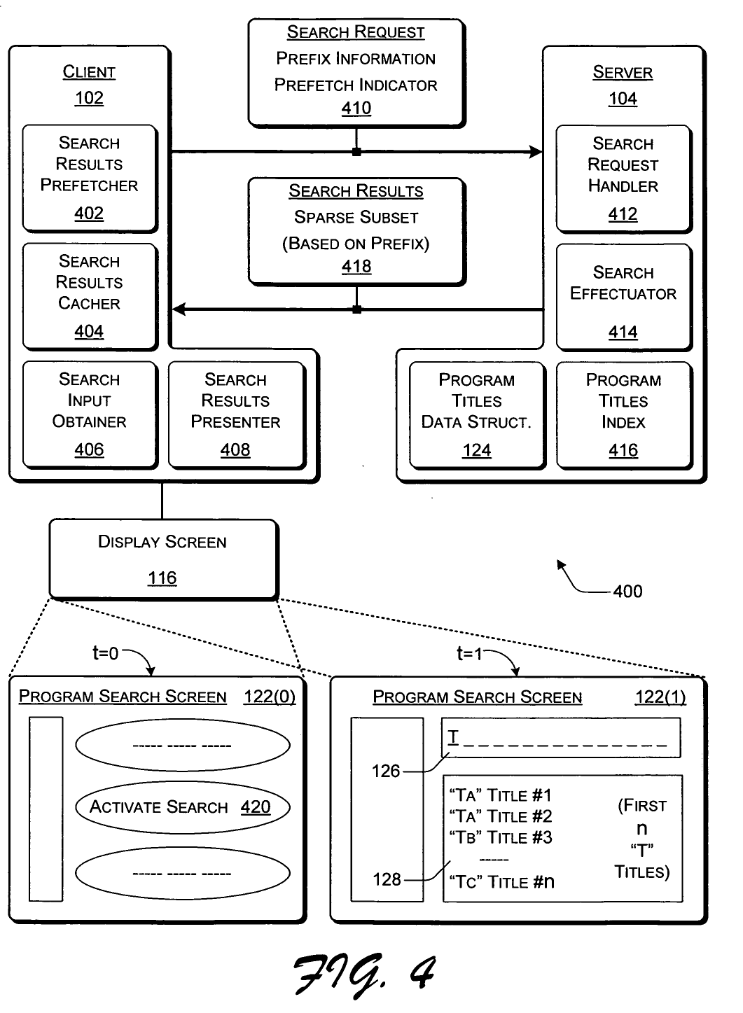

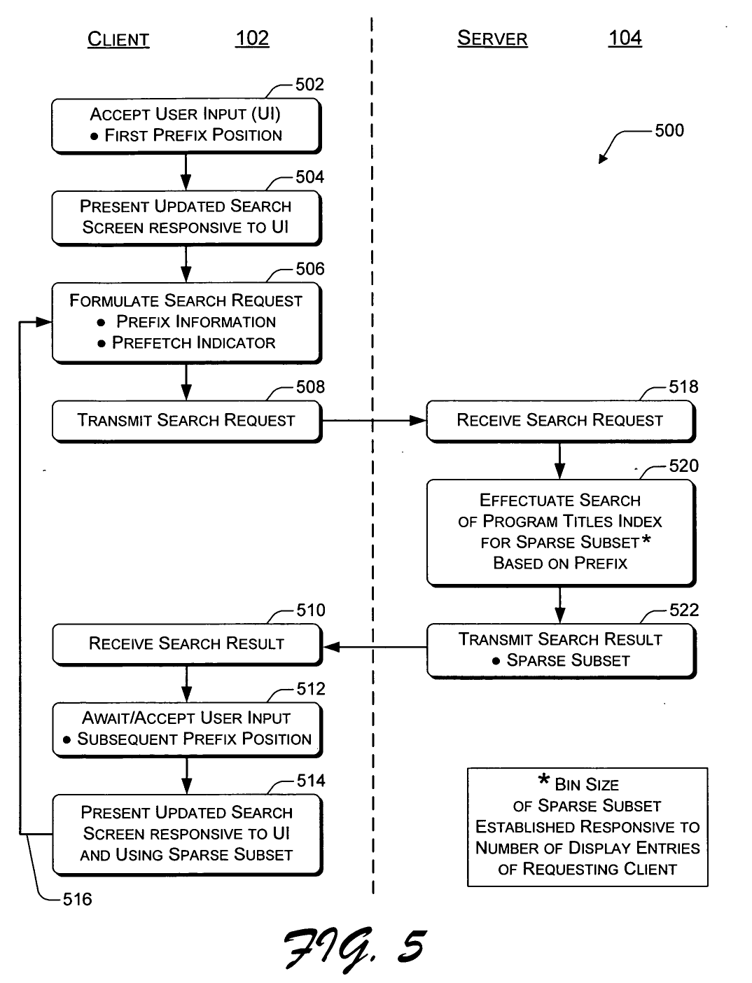

Alternatively, the second and possibly subsequent search requests sent from client 102 may result in additional sparse subsets until two, three, or more characters have been input and a dense subset based on the multiple input characters is of a sufficiently small size. Additional details and permutations of such an interactive client-server data search are described further below with reference to FIGS. 4 and 5.

Interactive client-server data search is described herein primarily in the context of a television-based system. However, client 102 may more generally be any electronic device with an associated display screen 116, especially those having a display screen of relatively low resolution, as is described further below. Examples of such client devices 102 include set-top boxes, mobile phones, personal digital assistants (PDAs), console and portable gaming devices, and so forth. Similarly, server 104 may generally be any server that is accessible by a network and is coupled to or otherwise has access to program data base 118, or at least program titles data structure 124. Hence, communication channel 120 may be comprised of one or more network links of networks that operate in a wired and/or wireless manner.

Example of Indexes and Sparse Subsets Related Thereto for a Program Title Data Structure

FIG. 2 illustrates an example of an index 202(0) and a sparse subset 204(0) with regard to a zero-character prefix for a program titles data structure 124. Generally, an index 202 is a data structure that indexes the words and characters of program titles data structure 124. Indexes 202 can be configured for zero-character prefixes, one-character prefixes, two-character prefixes, three-character prefixes, etc. as input by a user at a client 102. Similarly, sparse subsets 204 can also be configured for zero-character prefixes, one-character prefixes, two-character prefixes, three-character prefixes, and so forth.

As illustrated in FIG. 2, index 202(0) is configured with regard to a zero-character prefix. Hence, index 202(0) is tailored for use when a search is initially activated by a user prior to the inputting of any characters. Correspondingly, sparse subset 204(0) is configured with regard to a zero-character prefix as well.

Characters may be alphanumeric characters (e.g., letters and numbers), international characters, punctuation marks, other symbols, and so forth. It should be noted that multiple keystrokes or button presses (sequentially or simultaneously) may be used to generate a single character (e.g., to input Japanese characters). Regardless, indexes 202 and sparse subsets 204 are described below using a 26-character character set of 26 letters.

Thus, in a described implementation, index 202(0) includes 26 segments for 26 characters A, B, C . . . Z. Being configured for zero-character prefixes, each segment of index 202(0) is associated with one (as-of-yet not inputted) character. Each segment of index 202(0) also links or corresponds to a bin 206(0) of sparse subset 204(0). Specifically, sparse subset 204(0) includes 26 bins 206(0). These 26 bins 206(0) are for the 26 characters A, B, C . . . Z and are indicated by 206(0)-A, 206(0)-B, 206(0)-C . . . 206(0)-Z, respectively. For example, when a user initially activates a search, the 26 bins 206(0) of sparse subset 204(0) are prefetched from server 104 and returned to client 102 to prepare for inputting of the first character.

The bin size of each bin 206(0) is established responsive to the number “n” of display entries for the requesting client 102. Consequently, at least the first “n” titles for each character of the 26 characters are present in each bin 206(0). There are therefore “n” segments in each bin 206(0). Alternatively, each bin 206 may have a few more titles than “n”. For example, “n” may be selected for a maximum number of display entries for all devices that may be requesting a search. Regardless, each sparse subset 204 includes segments for each particular bin 206 corresponding to a given character or character combination, for each existing character prefix for a relevant character set, without including all possible matching segments of each such particular bin 206. In other words, each sparse subset 204 has bins 206 that do not include all possible titles based on a given prefix; on the other hand, bins of a dense subset (not shown) do include all possible titles based on a given prefix.

Each segment of each bin 206(0) is associated with one of these first “n” titles and corresponds to a universal resource identifier (URI) of the associated titled program. For example, when a user inputs the character “C” as the first letter of a search, the “n” titles from the “C” bin 206(0)-C of sparse subset 204(0) are presented on display screen 116 by client search application 112.

FIG. 3 illustrates an example of an index 202(1)-T and a sparse subset 204(1)-T with regard to a one-character prefix for a program titles data structure 124. As illustrated in FIG. 3, index 202(1)-T is configured with regard to a one-character prefix, which is “T” in this example. Hence, index 202(1)-T is tailored for use when a user inputs “T” as a first character of a search. Correspondingly, sparse subset 204(1)-T is configured with regard to the one-character prefix “T” as well.

In this described implementation, index 202(1)-T includes 26 segments having two-character fields for TA, TB, TC, TD, TE . . . TY, and TZ. Being configured for one-character prefixes, each segment of index 202(1)-T is associated with one already-inputted character (e.g., “T”) and one (as-of-yet not inputted) character. Each segment of index 202(1)-T also links or corresponds to a bin 206(1)-T of sparse subset 204(1)-T, or to an empty set (e.g., “<NONE>”, a null vector, etc.) if there are no titles starting with an associated character combination.

Specifically, sparse subset 204(1)-T includes up to 26 bins 206(1)-T and up to 23 bins 206(1)-T as shown. These 23 bins are for the 23 two-character combinations TA, TC, TE . . . TY and are indicated by 206(1)-TA, 206(1)-TC, 206(1)-TE . . . 206(1)-TY, respectively. For example, after a user inputs “T” as a first character of a search, the (up to) 23 bins 206(1)-T of sparse subset 204(1)-T are prefetched from server 104 and returned to client 102 to prepare for inputting of the second character.

The bin size of each bin 206(1)-T continues to be established responsive to the number “n” of display entries for the requesting client 102. Consequently, the first “n” titles for each two-character combination of the relevant 23 two-character combinations are present in each bin 206(1)-T. If there are not “n” titles for a given character combination (e.g., “TC”), then the segments of the bin thereof (e.g., bin 206(1)-TC) end prior to “n” segments. Otherwise, there are therefore “n” segments in each bin 206(1)-T, with each segment of each bin 206(1)-T being associated with one of these first “n” titles and corresponding to a URI of the associated titled program. For example, when a user inputs the character “E” as the second letter of a search following the inputting of the character “T”, the “n” titles from the “TE” bin 206(1)-TE of sparse subset 204(1)-T are presented on display screen 116 by client search application 112.

Example Approaches and Methods for Interactive Client-Server Data Search

FIG. 4 is a block diagram 400 illustrating an example of an approach to a client-server interactive data search in which a search request 410 having prefix information and search results 418 having a sparse subset are exchanged between a client 102 and a server 104. As part of the search function, client 102 produces on display screen 116 program search screen 122. As illustrated, a program search screen 122(0) is presented on display screen 116 at time=0 prior to the inputting of any characters, and a program search screen 122(1) is presented on display screen 116 at time=1 after one character (e.g., “T”) has been input.

Client 102 includes a search results prefetcher 402, a search results cacher 404, a search input obtainer 406, and a search results presenter 408. These four components may be located at memory 110(C) (of FIG. 1) and functional in conjunction with processor 108(C). Additionally, one or more of these four components may comprise all or part of client search application 112.

Search input obtainer 406 obtains search-related user inputs via program search screens 122. Such user inputs may be to activate a search 420, to input characters at character input field 126, and so forth.

Search results prefetcher 402 formulates search requests 410 with prefix information based on user input accepted through search input obtainer 406. Search requests 410 are transmitted from client 102 to server 104. In response to sending a search request 410, search results 418 are received from server 104 at client 102. Search results 418 includes a sparse subset 204 with multiple bins 206.

Search results cacher 404 caches received search results 418 until additional or subsequent user input accepted through search input obtainer 406 indicates a selected bin 206 of sparse subset 204. Search results presenter 408 then presents the bin 206 for the selected character (including selected character combination) at search results field 128 of program search screen 122(1).

Server 104 includes a search request handler 412, a search effectuator 414, a program titles index 416, and program titles data structure 124. These four components may be located at memory 110(S) (of FIG. 1) and functional in conjunction with processor 108(S). Program titles index 416 and program titles data structure 124 may alternatively be located at program database 118. Additionally, one or more of these four components may comprise all or part of server search application 114.

Search request handler 412 receives search requests 410 from client 102 and forwards them to search effectuator 414. Program titles index 416 is an index to words and characters of program titles data structure 124. Hence, program titles index 416 includes, for example, index 202(0) (of FIG. 2), index 202(1)-T (of FIG. 3), etc. for a zero-character prefix, for one-character prefixes, for two-character prefixes, and so forth.

Search effectuator 414 causes a search to be preformed on program titles index 416 based on the prefix information of a received search request 410. Search results 418, which includes a sparse subset 204, is produced from the search. Search results 418 are then transmitted from server 104 to client 102.

In operation, a user causes program search screen 122(0) to appear on display screen 116 through one or a series of key presses. When search input obtainer 406 detects an initial search activation 420 (which may be when program search screen 122(0) is first ordered to appear by user input), search input obtainer 406 notifies search results prefetcher 402.

Search results prefetcher 402 formulates a search request 410 with prefix information and a prefetch indicator. The prefix information is a zero-character prefix for an initial search request 410. The prefetch indicator is included to notify server 104 that a sparse subset 204 may be returned. A separate prefetch indicator may be omitted if all search requests are for sparse subsets 204, if a format used by search request 410 is reserved for prefetching of sparse subsets 204, and so forth.

Search results prefetcher 402 has search request 410 transmitted from client 102 to server 104 (e.g., over communication channel 120 via communication interfaces 106(C) and 106(S) (of FIG. 1)). Search request handler 412 receives search request 410 at server 104 from client 102. Search request handler 412 forwards search request 410 to search effectuator 414.

Search effectuator 414 effectuates a search of program titles index 416 based on the prefix information of search request 410. At this initial searach time, the prefix information comprises a zero-character prefix; consequently, search effectuator 414 searches index 202(0) (of FIG. 2) and retrieves sparse subset 204(0). Each bin 206(0) of sparse subset 204(0) has a bin size established responsive to a number “n” of entries displayed or displayable by client 102 on display screen 116 (including as defined by search results field 128 of program search screen 122(1)).

Server 104 may already know the value of “n” because it has been previously informed of “n”, because all such clients 102 have the same “n” value, and so forth. Otherwise, client 102 may inform server 104, and thus search effectuator 414, of the value of “n” in the initial search request 410 and optionally in each search request 410.

Search effectuator 414 therefore produces search results 418 from a search of program titles index 416. Search results 418 includes sparse subset 204(0) that is based on the prefix information and that has bins 206 of a size that is established responsive to the number “n” of display entries of client 102. Search effectuator 414 has search results 418 transmitted from server 104 to client 102 (e.g., over communication channel 120 via communication interfaces 106(S) and 106(C)). Search results cacher 404 receives search results 418 at client 102 from server 104. Search results cacher 404 stores search results 418 until additional user input is detected. In an alternative implementation, the initial sparse subset 204(0) may be constantly stored at client 102 (e.g., at memory 110(C)).

Before, during, or after search results prefetcher 402 begins formulating and/or transmitting search request 410, search input obtainer 406 causes search results presenter 408 to update program search screen 122 to prepare for accepting one or more user input characters and for presenting search results. Specifically, program search screen 122(1) is presented on display screen 116 so that character input field 126 and search results field 128 are visible to the user.

When a user inputs a character at character input field 126 (e.g., the character “T” as illustrated), search input obtainer 406 detects the input character and forwards the input character to search results cacher 404. Consequently, search results cacher 404 forwards the bin 206 identified by the input character (e.g., bin 206(0)-T (not explicitly shown) in this example) of sparse subset 204(0) to search results presenter 408.

Search results presenter 408 then presents the titles included in the segments of the bin 206 identified by the input character at search results field 128. In this example, there are not “n” titles starting with “TA”, so some titles starting with “TB” and “TC” are also presented at search results field 128. In short, the first “n” “T” titles are presented from bin 206(0)-T at search results field 128. The presented titles can be in actuality or can be associated with the URIs corresponding to the segments of the bin 206.

Before, during, or after when search input obtainer 406 causes search results cacher 404 and search results presenter 408 to present the identified “T” titles, search input obtainer 406 also notifies search results prefetcher 402 of the one-character prefix “T”. This one-character prefix “T” is used as the prefix information in the formulation of a second search request 410, which is transmitted to server 104.

When search request handler 412 forwards the second search request 410 to search effectuator 414, search effectuator 414 effectuates a search of program titles index 416 based on the one-character prefix “T”. Thus, a search of index 202(1)-T produces a sparse subset 204(1)-T which is included as (at least part of) second search results 418. This second search results 418 is transmitted to client 102 for storage at search results cacher 404. Hence, when user input of a second character after the first “T” character is detected by search input obtainer 406, search results cacher 404 and search results presenter 408 can cause presentation of titles for the identified two-character combination at search results field 128 without waiting for a response from server 104.

The division of duties as described above may differ for different implementations. For example, search results cacher 404 may forward an entire sparse subset 204 to search results presenter 408, and search results presenter 408 may extract the identified bin 206 therefrom in response to user input identifying the next character. Regardless, search results cacher 404 and search results presenter 408 jointly function to display a selected or identified bin 206 of a sparse subset 204. As another example, search request handler 412 may be responsible for transmitting a search request 410 to client 102 after search effectuator 414 has completed a search of program titles index 416.

FIG. 5 is a flow diagram 500 that illustrates an example of a method for performing an interactive client-server data search responsive to user input along with a search results presentation. Flow diagram 500 includes ten (10) blocks 502-514 and 518-522. Although the actions of flow diagram 500 may be performed in other environments and with a variety of hardware and software implementations, FIGS. 1-4 are used in particular to illustrate certain aspects and examples of the method. For example, a client 102 may perform the actions of blocks 502-514 and arrow 516, and a server 104 may perform the actions of blocks 518-522.

At block 502, user input (UI) is accepted for a first prefix position. For example, search input obtainer 406 may obtain user input from program search screen 122. At this point of this example, the user input of block 502 is considered to constitute a search activation. Thus, search input obtainer 406 may, for instance, detect that the user input is a search activation 420.

At block 504, an updated search screen is presented responsive to the user input. For example, search input obtainer 406 may cause a displayed screen to transition from a general menu screen, such as program search screen 122(0), to a specific search screen, such as program search screen 122(1).

At block 506, a search request is formulated with prefix information and optionally a prefetch indicator. For example, search results prefetcher 402 may formulate an initial search request 410 that includes prefix information and a prefetch indicator. For instance, the prefix information may be a zero-character prefix responsive to the initial search activation. It should be noted that the actions of blocks 504 and 506/508 in particular may be performed in any order, including fully or partially simultaneously.

At block 508, the formulated search request is transmitted. For example, search results prefetcher 402 of client 102 may transmit the initial search request 410 to server 104. At block 518, the search request is received. For example, search request handler 412 may receive the search request 410 at server 104.

At block 520, a search of a program titles index to produce a sparse subset based on the prefix information is effectuated. A bin size of the sparse subset is established responsive to a number of display entries of the requesting client. For example, search effectuator 414 may search program titles index 416 to produce a sparse subset 204(0) based on a zero-character prefix of the prefix information. Sparse subset 204(0) therefore includes multiple bins 206(0), with a size of each bin 206(0) established responsive to a number of displayable entries at search results field 128 of client 102. Each bin 206(0) corresponds to a single character based on the zero-character prefix.

At block 522, a search result including the sparse subset is transmitted. For example, search effectuator 414 of server 104 may transmit search result 418 to client 102. At block 510, the search result is received. For example, search results cacher 404 may receive search result 418 at client 102 and store it thereat.

At block 512, additional user input is awaited and eventually accepted. The additional user input creates a subsequent prefix position. For example, search input obtainer 406 detects eventual subsequent user input. For instance, search input obtainer 406 obtains a first character from character input field 126.

At block 514, an updated search screen is presented responsive to the user input and using the sparse subset of the search result. For example, search results cacher 404 and search results presenter 408 extract from sparse subset 204(0) a bin 206(0) corresponding to the identified first character as input to character input field 126 and present the contents of the identified and extracted bin 206(0) at search results field 128 of program search screen 122(1).

As indicated by arrow 516, the method of flowchart 500 continues with block 506. Again, the actions of blocks 514 and 506/508 in particular may be performed in any order, including fully or partially simultaneously. In this subsequent iteration, subsequent prefix information of a subsequent formulated search request is a one-character prefix that is based on the identified character as input at block 512. Hence, the search effectuated at block 520 is based on this one input character and the resulting sparse subset 204(1) includes multiple bins 206(1) in which each bin corresponds to a two-character combination, the first of which is the identified first character.

An identified second subsequent character that is then input at block 512 is used to extract for presentation at block 514 the bin 206(1) corresponding to the resulting two-character combination. As indicated by arrow 516, the method of flowchart 500 may then continue for another iteration. Iterations may be repeated until a dense subset is transmitted to client 102 from server 104 (e.g., because such a dense subset has become sufficiently small) or until user input indicates that the user wishes to being scrolling manually through presented titles.

Although the description above is applicable to searching for any words in the titles of a program titles data structure 124, the described interactive client-server data search may also be applied to searching for the first words of the titles. Furthermore, although the description above focuses on searching for words in titles, the described interactive client-server data search may also be applied to searching for words of program descriptions in general, possibly including titles, subject matter, story synopsis, creative contributors (e.g., director, produce, screenwriter, actors, actresses, etc.), and so forth. Closed captioning text of programs may also be searched.

As noted above, interactive client-server data search as described herein is also applicable to mobile phones, PDAs, console and portable gaming devices, and so forth. Consequently, the searching is not limited to television-program-related data structures. Instead, interactive client-server data searches may also be applied to searching words and characters of any elements of any data collection. For example, elements of “white pages” data collections may be searched as described herein. As another example, elements of a data collection of game descriptions and/or tips and cheats may be searched as described herein.

The devices, actions, aspects, features, procedures, components, etc. of FIGS. 1-5 are illustrated in diagrams that are divided into multiple blocks. However, the order, interconnections, interrelationships, layout, etc. in which FIGS. 1-5 are described and/or shown is not intended to be construed as a limitation, and any number of the blocks can be modified, combined, rearranged, augmented, omitted, etc. in any manner to implement one or more systems, methods, devices, procedures, media, apparatuses, servers, clients, arrangements, etc. for interactive client-server data searches. Furthermore, although the description herein includes references to specific implementations, the illustrated and/or described implementations can be implemented in any suitable hardware, software, firmware, or combination thereof and using any suitable device architecture(s), television network element(s), data structure organization(s), network protocol(s), display screen format(s), and so forth.

Implementations for interactive client-server data searches may be described in the general context of processor-executable instructions. Generally, processor-executable instructions include routines, programs, protocols, objects, interfaces, components, data structures, etc. that perform and/or enable particular tasks and/or implement particular abstract data types. Interactive client-server data searches, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or diagrams described. Rather, the specific features and diagrams are disclosed as exemplary forms of implementing the claimed invention.

1. One or more processor-accessible media comprising processor-executable instructions that, when executed, direct a device to perform actions comprising:
accepting a first user input for a first prefix position;
updating a search screen responsive to the first user input;
formulating a first search request having first prefix information responsive to the first user input;
storing a sparse subset of search results for the first search request;
accepting a second user input for a second prefix position; and
updating the search screen responsive to the second user input using the sparse subset of search results for the first search request.

2. The one or more processor-accessible media as recited in claim 1, wherein the action of updating the search screen responsive to the second user input comprises actions of:
extracting a portion of the sparse subset of search results for the first search request responsive to the second user input; and
presenting the extracted portion of the sparse subset of search results for the first search request on a display screen associated with the device.

3. The one or more processor-accessible media as recited in claim 1, wherein the processor-executable instructions, when executed, direct the device to perform further actions comprising:
formulating a second search request having second prefix information responsive to the second user input;
storing a sparse subset of search results for the second search request;
accepting a third user input for a third prefix position; and
updating the search screen responsive to the third user input using the sparse subset of search results for the second search request.

4. The one or more processor-accessible media as recited in claim 3, wherein the first prefix position comprises a zero-character prefix, the second prefix position comprises a one-character prefix, and the third prefix position comprises a two-character prefix.

5. The one or more processor-accessible media as recited in claim 1, wherein the sparse subset of search results for the first search request comprises multiple bins with each bin of the multiple bins corresponding to a single character.

6. The one or more processor-accessible media as recited in claim 1, wherein the sparse subset of search results for the first search request comprises multiple bins with each bin of the multiple bins corresponding to a two-character combination, a first character of the two-character combination comprising a previously-input character.

7. The one or more processor-accessible media as recited in claim 1, wherein the sparse subset of search results for the first search request comprises multiple bins with each bin having a number of segments established responsive to a number of displayable entries of the device.

8. The one or more processor-accessible media as recited in claim 1, wherein the first user input comprises a search activation, the first prefix information comprises a zero-character prefix, and the sparse subset of search results comprises an initial sparse subset.

9. The one or more processor-accessible media as recited in claim 1, wherein the processor-executable instructions, when executed, direct the device to perform further actions comprising:
sending the first search request to a server; and
receiving the sparse subset of search results for the first search request from the server, wherein the sparse subset of search results is based on the first prefix position of the first user input.

10. The one or more processor-accessible media as recited in claim 1, wherein the one or more processor-accessible media comprise at least one of (i) one or more storage media or (ii) one or more transmission media.

11. A server that is capable of receiving a search request having prefix information, the server adapted to perform a search of a data collection to produce a sparse subset of search results based on the prefix information; the sparse subset of search results including multiple bins, each bin of the multiple bins corresponding to a character combination that begins with a prefix of the prefix information.

12. The server as recited in claim 11, wherein the server comprises at least part of a headend of television-based system; and wherein the data collection comprises a program description index.

13. The server as recited in claim 12, wherein the program description index comprises a program titles index; and wherein the search focuses on a first word of each title in the program titles index.

14. The server as recited in claim 11, wherein the sparse subset of search results includes a corresponding bin of the multiple bins for each existing character prefix of a relevant character set, each particular bin of the multiple bins including at least one matching segment without including all matching segments of a corresponding particular character prefix.

15. The server as recited in claim 11, wherein each bin of the multiple bins includes a number of segments that is established responsive to a number of display entries of a client that transmitted the search request.

16. The server as recited in claim 11, wherein each bin of the multiple bins includes multiple segments; and wherein each segment of the multiple segments is associated with one or more words of an element of multiple elements of the data collection.

17. The server as recited in claim 16, wherein each segment of the multiple segments corresponds to a universal resource identifier (URI) for the element having the associated one or more words.

18. A method comprising:
accepting search-related user input;
transmitting from a client, responsive to the accepting, a search request having prefix information based on the search-related user input;
receiving at a server the search request having the prefix information;
effectuating a search of a data collection to produce a sparse subset of search results based on the prefix information;
transmitting the sparse subset of search results from the server;
receiving the sparse subset of search results at the client; and
storing the sparse subset of search results.

19. The method as recited in claim 18, wherein the effectuating comprises:
effectuating the search of the data collection to produce the sparse subset of search results based on the prefix information, wherein the data collection comprises at least one of television programming information, telephone directory information, or game-related information.

20. The method as recited in claim 18, wherein the effectuating comprises:
effectuating the search of the data collection to produce the sparse subset of search results based on the prefix information; wherein the sparse subset of search results includes multiple bins, each bin corresponding to the prefix information plus one additional character.

21. The method as recited in claim 18, wherein the effectuating comprises:
effectuating the search of the data collection to produce the sparse subset of search results based on the prefix information; wherein the sparse subset of search results includes multiple bins, each bin including a number of segments that is established responsive to a number of display entries of the client.

22. The method as recited in claim 18, further comprising:
accepting subsequent search-related user input, the subsequent search-related user input comprising a subsequent character; and
presenting contents of a portion of the sparse subset of search results responsive to the subsequent character.

23. The method as recited in claim 22, further comprising:
transmitting from the client, responsive to the subsequent accepting, a subsequent search request having subsequent prefix information based on the subsequent search-related user input, the subsequent prefix information including a one-character prefix comprising the subsequent character.

24. The method as recited in claim 23, further comprising:
receiving at the server the subsequent search request having the subsequent prefix information;
effectuating a subsequent search of the data collection to produce a subsequent sparse subset of search results based on the subsequent prefix information;
transmitting the subsequent sparse subset of search results from the server;
receiving the subsequent sparse subset of search results at the client;
storing the subsequent sparse subset of search results;
accepting additional search-related user input, the additional search-related user input comprising an additional character; and
presenting contents of a portion of the subsequent sparse subset of search results responsive to the additional character.

25. A device comprising:
a search input obtainer that obtains a search-related user input, including a search activation or at least one character;
a search results prefetcher that formulates a search request having prefix information in response to the search-related user input obtained by the search input obtainer;
a search results cacher that caches a received sparse subset of search results, the sparse subset including multiple bins; and
a search results presenter that presents contents of an identified bin of the multiple bins responsive to additional user input.

26. The device as recited in claim 25, wherein the search-related user input comprises the search activation, the search request comprises an initial search request, the prefix information comprises a zero-character prefix, each bin of the multiple bins corresponds to a single character based on the zero-character prefix, and a size of each bin of the multiple bins is established responsive to a number of display entries of the device.

27. The device as recited in claim 25, wherein the search-related user input comprises the at least one character, the search request comprises a second search request, the prefix information comprises a one-character prefix, each bin of the multiple bins corresponds to a two-character combination based on the one-character prefix, and a size of each bin of the multiple bins is established responsive to a number of display entries of the device.

28. The device as recited in claim 27, wherein the size of each bin of the multiple bins is established to be equal to the number of display entries of the device.

29. The device as recited in claim 28, further comprising:
an associated display screen;
wherein the search input obtainer obtains the at least one character from a character input field displayed on the associated display screen, and the search results presenter presents the contents of the identified bin of the multiple bins at a search results field displayed on the associated display screen; and
wherein the number of display entries of the device is determined, at least partially, by a size of the search results field.

30. The device as recited in claim 27, wherein the size of each bin of the multiple bins is established to be greater than the number of display entries of the device but less than a bin size of a dense subset of search results.

31. The device as recited in claim 27, wherein the additional user input comprises the at least one character, and the identified bin is identified by the at least one character.

32. The device as recited in claim 25, wherein the device is adapted to transmit the search request to a server that performs a search on an indexed database to produce the sparse subset of search results; and wherein the device is further adapted to receive the sparse subset from the server.

33. The device as recited in claim 25, wherein the device comprises at least one of a television-based device, a mobile phone, a personal digital assistant (PDA), or a console or portable gaming device.

34. An arrangement for interactive client-server data searches, the arrangement comprising:
prefetch means for prefetching search results based on prefix information; and
display means for displaying a portion of sparse subsets prefetched by the prefetch means; the sparse subsets based on the prefix information and having multiple bins, each bin of the multiple bins of a size that is established responsive to a number of display entries.

35. The arrangement as recited in claim 34, further comprising:
obtainer means for obtaining search input from a user, the search input including a search activation and/or one or more characters;
wherein the prefetch means formulates a search request including the prefix information responsive to the search input obtained from the user by the obtainer means.

36. The arrangement as recited in claim 34, wherein the display means comprises:
cache means for caching the sparse subsets until additional user input is detected; and
presentation means for presenting contents of a bin of the multiple bins, with the bin identified by the additional user input of a character that follows a prefix of the prefix information.

37. The arrangement as recited in claim 34, wherein each bin of the multiple bins corresponds to a character of multiple characters that may be input after a prefix of the prefix information.

38. The arrangement as recited in claim 34, wherein the arrangement is capable of operating in conjunction with at least one of (i) a television-based network or (ii) a wireless telephone and/or data network.

39. The arrangement as recited in claim 34, wherein the arrangement comprises at least one of (i) one or more processor-accessible media or (ii) at least one device.

40. The arrangement as recited in claim 34, further comprising: server means for providing the sparse subsets from searches of a program titles index in response to receiving search requests having the prefix information from the prefetch means over a communications channel.
